(19) United States
(12) Patent Application Publication
(10) Pub. No.: US 2011/0025287 A1
(43) Pub. Date: Feb. 3, 2011

(54) REGULATOR CIRCUIT

(75) Inventor: Hiroki Inoue, Atsugi (JP)

Correspondence Address: FISH & RICHARDSON P.C. (DC), P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 12/843,482

(22) Filed: Jul. 26, 2010

(30) Foreign Application Priority Data
Jul. 28, 2009 (JP) 2009-175050

(51) Int. Cl. G05F 1/10

(52) U.S. Cl. 323/284

(57) ABSTRACT

An object of the present invention is to reduce variations in the value of the output potential VDD of a regulator circuit including a bias circuit referring threshold voltage. The regulator circuit includes a bias circuit referring threshold voltage, an error amplifier, an output control circuit, and a feedback voltage divider. Further, the regulator circuit uses an n-type transistor and p-type transistor which offer small variations in the value obtained by Vthn+|Vthp|. The feedback voltage divider includes a diode-connected p-type transistor. The increase in the threshold voltage Vthn of n-type transistors leads to the increase in the threshold voltage Vthp of the p-type transistor. Therefore, the on resistance of the p-type transistor is reduced. As a result, the fluctuations in the output potential VDD is suppressed.

### BACKGROUND OF THE INVENTION

1. Field of the Invention

The present invention relates to a regulator circuit which reduces variations in output voltage.

2. Description of the Related Art

FIG. 2 is a circuit diagram showing a conventional regulator circuit. This regulator circuit includes a bias circuit 10 referring threshold voltage, an error amplifier 20, an output control circuit 30, and a feedback voltage divider 40.

The bias circuit 10 generates reference potential Vref.

The error amplifier 20 amplifies potential difference between the reference potential Vref and feedback potential Vfb and outputs potential Vn2.

The output control circuit 30 controls output potential VDD of the regulator circuit and current to be output, by the potential Vn2.

The feedback voltage divider 40 divides a potential based on the output potential VDD by a resistor or the like, and gives a feedback as a feedback potential Vfb to the error amplifier 20.

Patent Document 1 proposes a voltage regulator including an input stage for amplifying a feedback voltage which is one of output voltages, a phase reversing stage for reversing the phase of an output from the input stage, and an output stage for supplying power voltage to a load Z, which is driven by the output of the phase reversing stage.

### [Patent Document 1] Japanese Published Patent Application No. 2000-39923

In the regulator circuit, the reference potential Vref generated by the bias circuit 10 referring threshold voltage depends on variations in the threshold voltage Vthn of an n-type transistor in the bias circuit 10.

Therefore, variations in the threshold voltage Vthn of the n-type transistor in the bias circuit 10 lead to variations in the reference voltage Vref, which results in the problem of variations in the value of the output voltage VDD of the regulator circuit.

### SUMMARY OF THE INVENTION

One embodiment of the present invention is a regulator circuit including a bias circuit referring threshold voltage, an error amplifier, an output control circuit, and a feedback voltage divider. The feedback voltage divider includes a diode-connected p-type transistor. In terms of threshold voltage Vthn of an n-type transistor in the bias circuit referring threshold voltage and threshold voltage Vthp of the p-type transistor in the bias circuit referring threshold voltage, a standard deviation 3σ of Vthn+|Vthp| is smaller than a standard deviation 3σ of the Vthn.

One embodiment of the present invention is a regulator circuit including a bias circuit referring threshold voltage, an error amplifier, an output control circuit, and a feedback voltage divider. The bias circuit referring threshold voltage includes first and second p-type transistors, first and second n-type transistors, and a first resistor. The feedback voltage divider includes a third p-type transistor and a second resistor. The output control circuit includes a fourth p-type transistor. The error amplifier includes fifth and sixth p-type transistors, and third to fifth n-type transistors. A gate of the first p-type transistor is electrically connected to a gate of the second p-type transistor and one of a source and drain of the second p-type transistor. One of a source and drain of the first p-type transistor is electrically connected to an input potential. The other one of the source and drain of the first p-type transistor is electrically connected to one of a source and drain of the first n-type transistor. A gate of the first n-type transistor is electrically connected to one end of the first resistor. The other one of the source and drain of the first n-type transistor is electrically connected to a ground potential. One of the source and drain of the second p-type transistor is electrically connected to one of a source and drain of the second n-type transistor. The other one of the source and drain of the second p-type transistor is electrically connected to the input potential. A gate of the second n-type transistor is electrically connected to the other one of the source and drain of the first p-type transistor. The other one of the source and drain of the second n-type transistor is electrically connected to one end of the first resistor. The other end of the first resistor is electrically connected to the ground potential. A gate of the third p-type transistor and one of a source and drain of the third p-type transistor are connect are electrically connected to one end of the second resistor. The other one of the source and drain of the third p-type transistor is electrically connected to one of a source and drain of the fourth p-type transistor. The other one of the source and drain of the fourth p-type transistor is electrically connected to the input potential. The other end of the second resistor is electrically connected to the ground potential. One of a source and drain of the fifth p-type transistor is electrically connected to the input potential. The other one of the source and drain of the fifth p-type transistor is electrically connected to one of a source and drain of the third n-type transistor and a gate of the fourth p-type transistor. One of a source and drain of the sixth p-type transistor is electrically connected to the input potential. The gate and the other one of the source and drain of the sixth p-type transistor are electrically connected to a gate of the fifth p-type transistor. A gate of the third n-type transistor is electrically connected to a gate of the second n-type transistor. The other one of the source and drain of the third n-type transistor is electrically connected to one of a source and drain of the fifth n-type transistor. A gate of the fourth n-type transistor is electrically connected to the one end of the second resistor. One of a source and drain of the fourth n-type transistor is electrically connected to the other one of the source and drain of the sixth p-type transistor. A gate of the fifth n-type transistor is electrically connected to the one end of the first resistor. The other one of the source and drain of the fifth n-type transistor is electrically connected to the ground potential. In terms of a threshold voltage Vthn of the first and second n-type transistors and a threshold voltage Vthp of the third p-type transistor, a standard deviation 3σ of the sum of Vthn and |Vthp|(Vthn+|Vthp|) is smaller than a standard deviation 3σ of the Vthn.

One embodiment of the present invention produces an effect of reducing variations in the value of the output potential VDD of a regulator circuit including a bias circuit referring threshold voltage, and stabilizing the output potential VDD.

### BRIEF DESCRIPTION OF THE DRAWINGS

FIG. 1 is a circuit diagram of a regulator circuit.

FIG. 2 is a circuit diagram of a conventional regulator circuit.

FIG. 3 is a diagram showing the characteristics of the threshold voltage of an n-type transistor and p-type transistor in the regulator circuit.

FIG. 4 is a diagram showing one example of the configuration of a noncontact data-carrier using the regulator circuit.

FIGS. 5A to 5D are cross-sectional views showing the fabrication method of the transistors.

FIG. 6A is a diagram showing comparison between the measurements of the output voltage of the conventional regulator circuit in FIG. 2, and FIG. 6B is a diagram showing comparison between the measurements of the output voltage of the regulator circuit in FIG. 1.

### DETAILED DESCRIPTION OF THE INVENTION

Embodiments of the present invention disclosed will hereinafter be described with reference to the drawings. Note that the present invention is not limited to the following description, and those skilled in the art can easily understand that modes and details of the invention can be changed in various ways without departing from the purpose and the scope of the present invention. Therefore, it should be noted that the present invention should not be interpreted as being limited to the following description of the embodiments.

### Embodiment 1

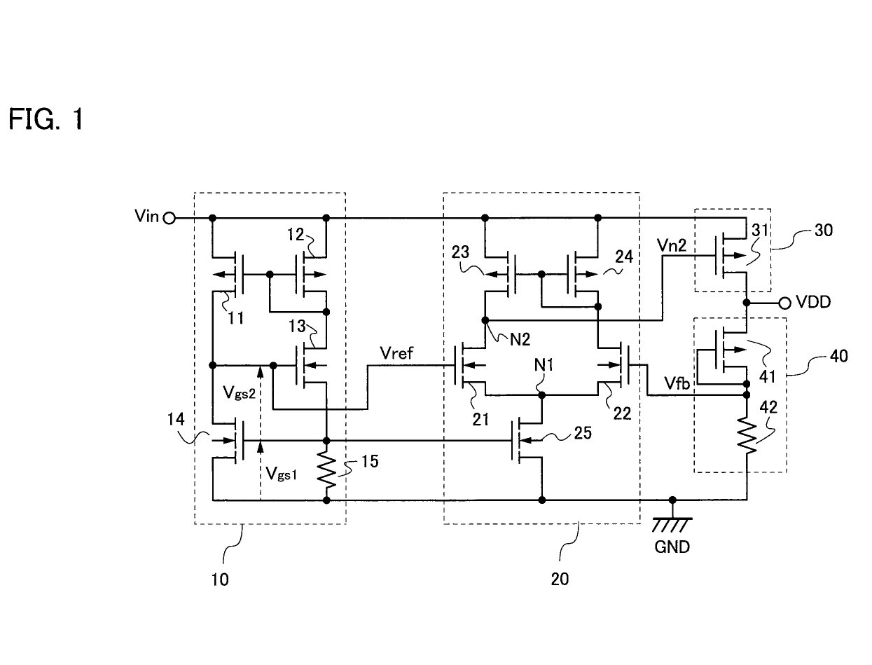

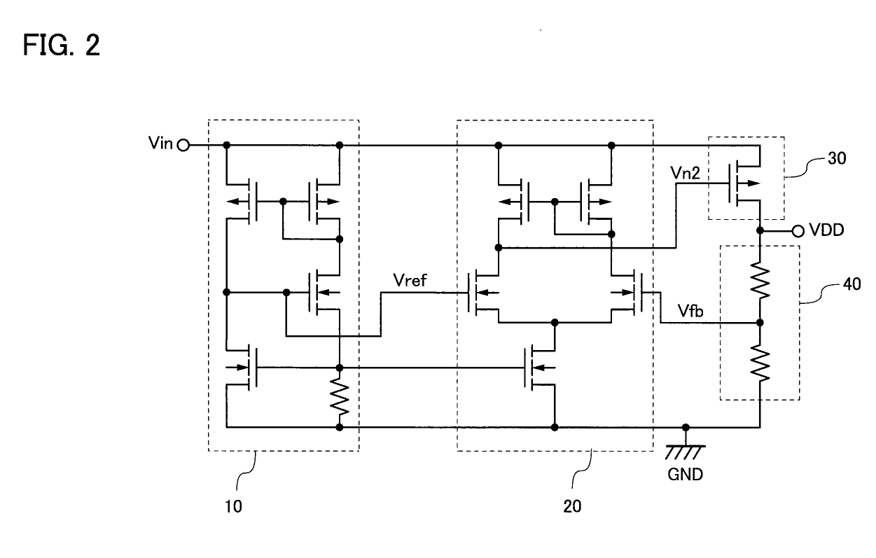

FIG. 1 is a circuit diagram of a regulator circuit in this embodiment. This regulator circuit includes the bias circuit 10 referring threshold voltage, the error amplifier 20, the output control circuit 30, and the feedback voltage divider 40, as in FIG. 2.

The bias circuit referring threshold voltage needs a small number of transistors, preventing the increase in the circuit area. Further, the bias circuit can achieve a low operating voltage and low power consumption. Therefore, the use of a regulator circuit provided with a bias circuit referring threshold voltage as a regulator circuit which is to be provided to a noncontact data-carrier or the like for a wireless communication system using RFID is useful.

The bias circuit 10 includes p-type transistors 11 and 12, n-type transistors 13 and 14, and a resistor 15 (“p-type transistor” and “n-type transistor” may hereinafter simply be referred to as “transistor”).

Here, the transistors are thin film transistors using silicon for the channel layers. Note that the transistors may be not only single gate transistors but multi gate transistors such as double gate transistors.

The transistor 11 and the transistor 14 are connected in series between input potential Vin and ground potential GND. The gate and drain of the transistor 12 are connected to the gate of the transistor 11 used for a current mirror. Accordingly, the value of a current flowing through the transistor 11 is equal to the value of a current flowing through the transistor 12.

Further, the source of the transistor 12 is connected to the input potential Vin, and the drain of the transistor 12 is connected to the ground potential GND via the n-type transistor 13 and the resistor 15.

Note that the ground potential GND is not limited to 0 V; the ground potential GND is a potential to be a reference of the circuit.

The transistor 13 is provided in order to secure the operation of the transistor 14 in the saturation region.

I_{d1}, drain current, in the saturation region of the transistor 14 is expressed by an equation (1).

$$[ FORMULA 1 ]$$

$${I}_{d 1} = μ \frac{{C}_{ox} {W}_{1}}{2 {L}_{1}} {( {V}_{gs 1} - {V}_{thn 1} )}^{2} \qquad ( 1 )$$

Here μ is electron mobility, Cₒₓ is gate-oxide capacitance per unit area, W₁ is the channel width of the transistor 14, L₁ is the channel length of the transistor 14, and Vₜₕₙ₁ is the threshold voltage of the transistor 14.

According to the equation (1), V_{gs1}, gate-source voltage, of the transistor 14, is expressed by an equation (2).

$$[ FORMULA 2 ]$$

$${V}_{gs 1} = {V}_{thn 1} + \sqrt{\frac{2 {I}_{d 1} {L}_{1}}{μ {C}_{ox} {W}_{1}}} \qquad ( 2 )$$

Meanwhile, a voltage equal to the Vgs of the transistor 13 is applied between the gate and drain of the transistor 14.

I_{d2}, drain current, of the transistor 13 is expressed by an equation (3).

$$[ FORMULA 3 ]$$

$${I}_{d 2} = μ \frac{{C}_{ox} {W}_{2}}{2 {L}_{2}} {( {V}_{gs 2} - {V}_{thn 2} )}^{2} \qquad ( 3 )$$

Here μ is electron mobility, Cₒₓ is gate-oxide capacitance per unit area, W₂ is the channel width of the transistor 13, L₂ is the channel length of the transistor 13, and Vₜₕₙ₂ is the threshold voltage of the transistor 13.

According to the equation (3), the gate-source voltage V_{gs2} of the transistor 13 is expressed by an equation (4).

$$[ FORMULA 4 ]$$

$${V}_{gs 2} = {V}_{thn 2} + \sqrt{\frac{2 {I}_{d 2} {L}_{2}}{μ {C}_{ox} {W}_{2}}} \qquad ( 4 )$$

Here the reference potential Vref is the sum of V_{gs1} and V_{gs2}. Therefore, the following equation (5) holds true.

$$[ FORMULA 5 ]$$

$$\begin{matrix}{V}_{ref} = {V}_{gs 1} + {V}_{gs 2} \\ = {V}_{thn 1} + {V}_{thn 2} + \sqrt{\frac{2}{μ {C}_{ox}}} ( \sqrt{\frac{{I}_{d 1} {L}_{1}}{{W}_{1}}} + \sqrt{\frac{{I}_{d 2} {L}_{2}}{{W}_{2}}} )\end{matrix} \qquad ( 5 )$$

According to the equation (5), it is understood that the reference potential Vref increases as the threshold voltage Vthn of the n-type transistors 13 and 14 increases, and decreases as the threshold voltage Vthn of the n-type transistors 13 and 14 decreases.

Next, the error amplifier 20 will be described.

The error amplifier 20 includes an n-type transistor 21 having the gate to which the reference potential Vref is applied, and an n-type transistor 22 having the gate to which the feedback potential Vfb is applied. The drain of the transistor 21 is connected to the input potential Vin via a p-type transistor 23 and the drain of the transistor 22 is connected to the input potential Vin via a p-type transistor 24. Further, the source of the transistor 21 and the source of the transistor 22 are connected to a node N1.

An n-type transistor 25 which conducts constant current is connected between the node N1 and the ground potential GND.

The gate of the transistor 23 and the gate of the transistor 24 are connected to the drain of the transistor 22. Further, potential Vn2 is output from a node N2 to which the drain of the transistor 21 is connected.

Note that the configuration of the error amplifier 20 is not limited to the above; a suitable configuration can be selected as appropriate from those for amplifying a potential difference between two terminals, as the configuration of the error amplifier 20. Examples include a differential amplifier and an operational amplifier.

Next, the output control circuit 30 and the feedback voltage divider 40 will be described.

In the output control circuit 30 and the feedback voltage divider 40, a p-type transistor 31, a diode-connected p-type transistor 41, and a resistor 42 are connected in series between the input potential Vin and the ground potential GND. Further, the output potential VDD and the feedback potential Vfb are output from the source of the transistor 41 and the drain of the transistor 41, respectively.

Note that although single p-type transistor is shown in the feedback voltage divider 40 in FIG. 1, a plurality of diode-connected p-type transistors may be connected in series instead.

In addition, a diode-connected n-type transistor may be used instead of the resistor 42.

As described above, in the regulator circuit, the output potential VDD is stabilized by inputting the reference potential Vref to the error amplifier 20 and giving negative feedback by using the output control circuit 30 and the feedback voltage divider 40. Note that the feedback potential Vfb is controlled by negative feedback in order to be the same value as the reference potential Vref.

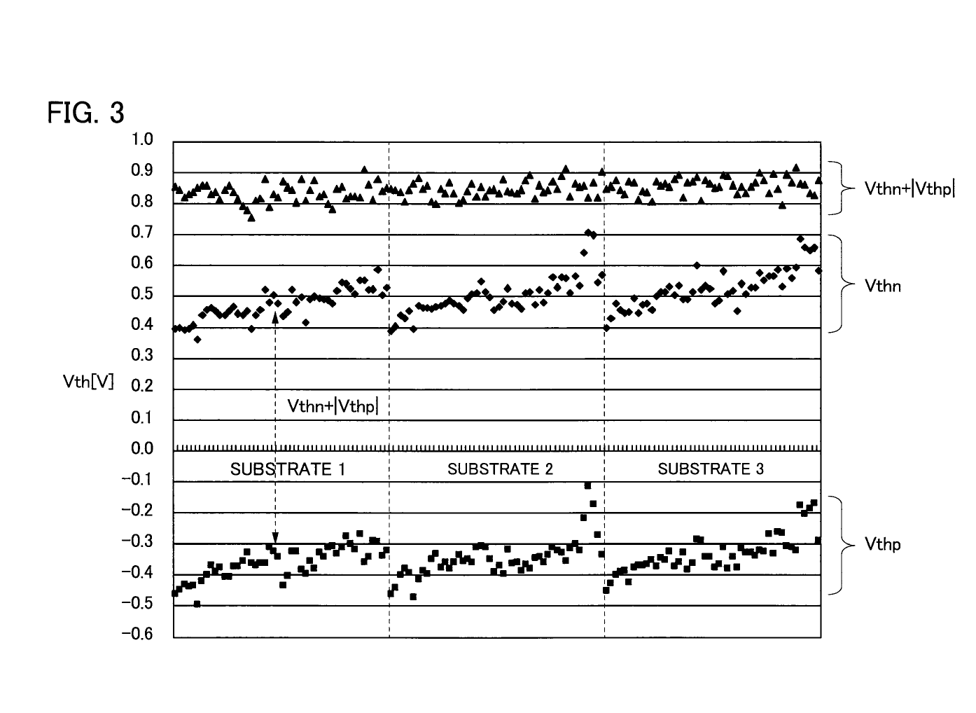

Next, the threshold-voltage characteristics of n-type transistors and p-type transistors in the regulator circuit will be described with reference to FIG. 3.

FIG. 3 is a graph showing the measurements of the threshold voltage Vth of the n-type transistors and p-type transistors. 48 measurement points of the n-type transistors and p-type transistors per substrate were measured. Note that distance between the n-type transistor and the p-type transistor in each measurement point is about 3000 μm.

From FIG. 3, for the Vthn of the n-type transistors in the regulator circuit and the Vthp of the p-type transistors in the regulator circuit, it can be seen that the Vthp increases as the Vthn increases, and the Vthp decreases as the Vthn decreases.

Accordingly, it can be said that variations among the n-type transistors and p-type transistors in the regulator circuit in terms of the sum of Vthn and |Vthp| (Vthn+|Vthp|) are small.

Here, the phrase “variations in the sum of Vthn and |Vthp|(Vthn+|Vthp|) are small” means that the standard deviation 3σ of the sum of Vthn and |Vthp|(Vthn+|Vthp|) is smaller than the standard deviation 3σ of the Vthn.

For example, in FIG. 3, the standard deviation 3σ of the Vthn is about 0.2 V, and the standard deviation 3σ of the sum of Vthn and |Vthp|(Vthn+|Vthp|) is about 0.1 V. Therefore, in this case, it can be said that variations in the value of Vthn+|Vthp| are small.

In the regulator circuit in FIG. 1, if at least the n-type transistors 13 and 14, and the p-type transistor 41 are characterized by small variations in the value of Vthn+|Vthp|, the value of the output potential VDD of the regulator circuit varies in a smaller range.

Note that in the regulator circuit in FIG. 1, distance between each of the n-type transistors 13 and 14 and the p-type transistor 41 is less than 3000 μm. Therefore, the n-type transistors 13 and 14, and the p-type transistor 41 are characterized by small variations in the value of Vthn+|Vthp|.

Next, the output potential VDD of the regulator circuit will be described.

The output potential VDD of the regulator circuit can be expressed by an equation (6).

$$[ FORMULA 6 ]$$

$$output potential VDD \approx reference potential Vref \times ( 1 + \frac{on \text{-} resistance of transistor 41 {R}_{1}}{esistance value of resistor 42 {R}_{2}} ) \qquad ( 6 )$$

According to the equation (6), it can be seen that in the regulator circuit, the output potential VDD fluctuates according to the ratio of R1 (the on-resistance of the transistor 41) to R2 (the resistance value of the resistor 42).

In the regulator circuit, as described above, the reference potential Vref increases as the threshold voltage Vthn of the n-type transistors 13 and 14 in the bias circuit 10 increases. The output potential VDD increases as the reference potential Vref increases.

However, the regulator circuit uses n-type transistors and p-type transistors which offer small variations in the value of Vthn+|Vthp|. Therefore, the threshold voltage Vthp of the p-type transistor 41 increases as the threshold voltage Vthn of the n-type transistors 13 and 14 increases. As a result, the on resistance of the p-type transistor 41 is reduced.

Therefore, according to the equation (6), it can be seen that the increase in the output potential VDD is suppressed.

Similarly, the reference potential Vref decreases as the threshold voltage Vthn of the n-type transistors 13 and 14 in the bias circuit 10 decreases. The output potential VDD decreases as the reference potential Vref decreases.

However, the regulator circuit uses n-type transistors and p-type transistors which offer small variations in the value of Vthn+|Vthp|. Therefore, the threshold voltage Vthp of the p-type transistor 41 decreases as the threshold voltage Vthn of the n-type transistors 13 and 14 decreases. As a result, the on resistance of the p-type transistor 41 is increased.

Therefore, according to the equation (6), it can be seen that the decrease in the output potential VDD is suppressed.

As described above, the regulator circuit uses the n-type transistors and p-type transistors which offer variations in the value of Vthn+|Vthp|, and the regulator circuit includes the diode-connected p-type transistor in the feedback voltage divider 40. This achieves the reduction in variations in the value of the output potential VDD of the regulator circuit including the bias circuit referring threshold voltage.

Therefore, the improvement in the yields of a device including the regulator circuit can be achieved.

### Embodiment 2

The regulator circuit in Embodiment 1 holds true even if the polarity of the transistors in the bias circuit and the feedback voltage divider is reversed.

That is, the bias circuit may refer threshold voltage Vthp of p-type transistor, and the feedback voltage divider may be formed using a diode-connected n-type transistor and a resistor.

Even if the polarity of the transistors in the bias circuit and the feedback voltage divider is reversed, an effect similar to that of the regulator circuit in Embodiment 1 can be given.

### Embodiment 3

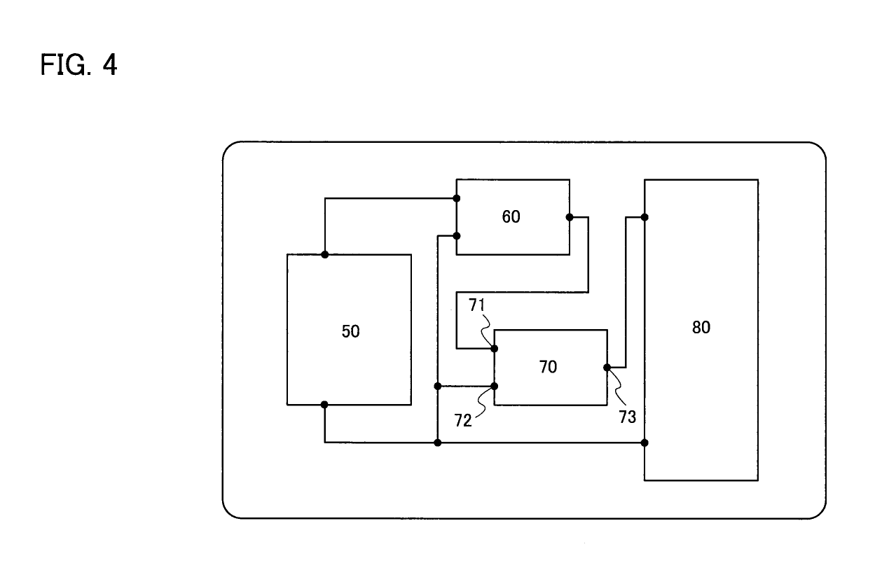

FIG. 4 shows a configuration example of a noncontact data-carrier equipped with the regulator circuit in Embodiments 1 and 2. The noncontact data-carrier includes an antenna circuit 50, a rectifier circuit 60, a regulator circuit 70, and an operating circuit 80.

The antenna circuit 50 transmits and receives a signal to/from a wireless communication device (not illustrated).

The rectifier circuit 60 rectifies a carrier wave that has been received by the antenna circuit 50 and generates DC voltage.

The DC voltage that has been generated by the rectifier circuit 60 is input to the regulator circuit 70 via an input power terminal 71 and a reference power terminal 72, and constant potential is extracted by the regulator circuit 70 via an output terminal 73 without depending on fluctuations in the output voltage of the rectifier circuit 60, and constant potential is supplied to the operating circuit 80.

The operating circuit 80 outputs a response signal for giving a response, in response to a command signal from the wireless communication device that is piggybacked onto the carrier wave.

The inner configuration of the operating circuit 80 is not particularly limited; a modulation circuit, a demodulation circuit, a memory, a signal processing circuit, or a coding circuit may be provided therein.

Since variations in the output potential VDD of the regulator circuit in Embodiments 1 and 2 are small, a circuit having a narrow margin of operating voltage can be selected as a subsequent circuit of the regulator circuit 70. In addition, the improvement in the yields can be achieved even if the circuit having a narrow margin of operating voltage is selected.

Further, since variations in the output potential VDD are small and the output potential VDD does not increase in an undesired way, a low-voltage circuit can be selected as a subsequent circuit of the regulator circuit 70. This can reduce manufacturing cost.

### Embodiment 4

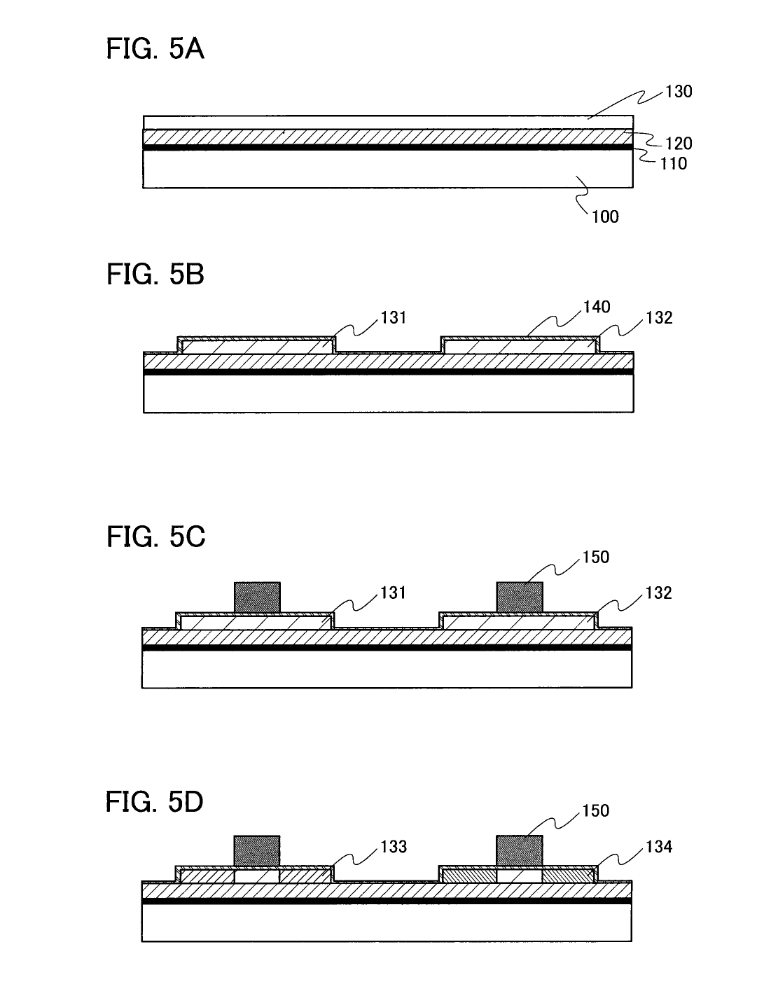

An example of the fabrication method of the n-type transistors and p-type transistors in the regulator circuit, which offer small variations in the value of Vthn+|Vthp| will be described with reference to FIGS. 5A to 5D.

After a substrate 100 is cleaned, a release layer 110 is formed over the substrate 100. Then, a base film 120 and an amorphous semiconductor film 130 are deposited over the release layer 110 (see FIG. 5A).

After the deposition of the amorphous semiconductor film 130, dehydrogenation is performed. Then, the amorphous semiconductor film 130 is crystallized by laser irradiation in order to be a crystalline semiconductor film.

After that, an impurity element giving n-type or p-type conductivity is added to the entire surface of the crystalline semiconductor film. This step allows the threshold voltage Vth of the transistor to be controlled.

Further, this step leads to small variations in the value of Vthn+|Vthp| that is based on the n-type transistors and p-type transistors each including an island-shaped semiconductor film made of the crystalline semiconductor film.

Note that this step is not necessarily performed.

Next, the crystalline semiconductor film is patterned and etched to form island-shaped semiconductor films 131 and 132. Then, an insulating film 140 is formed so as to cover the island-shaped semiconductor films 131 and 132 (see FIG. 5B).

Next, conductive films 150 are formed over the island-shaped semiconductor films 131 and 132 with the insulating film 140 therebetween (see FIG. 5C).

Next, an impurity element giving n-type conductivity is added using the conductive film 150 as a mask to the island-shaped semiconductor film 131 in order to form an n-type region 133 (see FIG. 5D).

At the time, an impurity element giving n-type conductivity is also added to the island-shaped semiconductor film 132. Note that the island-shaped semiconductor film 132 can be covered by a resist mask (not illustrated) so that the impurity element giving n-type conductivity is not added to the island-shaped semiconductor film 132.

Next, an impurity element giving p-type conductivity is added using the conductive film 150 as a mask to the island-shaped semiconductor film 132 in order to form a p-type region 134 (see FIG. 5D).

At the time, the island-shaped semiconductor film 131 needs to be covered by a resist mask (not illustrated).

The n-type transistor including the n-type region 133 and the p-type transistor including the p-type region 134 can be formed in such a manner.

After that, an interlayer dielectric, a passivation film, a sealing film or the like is formed so as to cover the n-type transistor and the p-type transistor if necessary. Further, it is also possible to form a flexible semiconductor device by separating the release layer 110 from the substrate 100 and providing the n-type transistor and the p-type transistor over a flexible substrate.

### Example

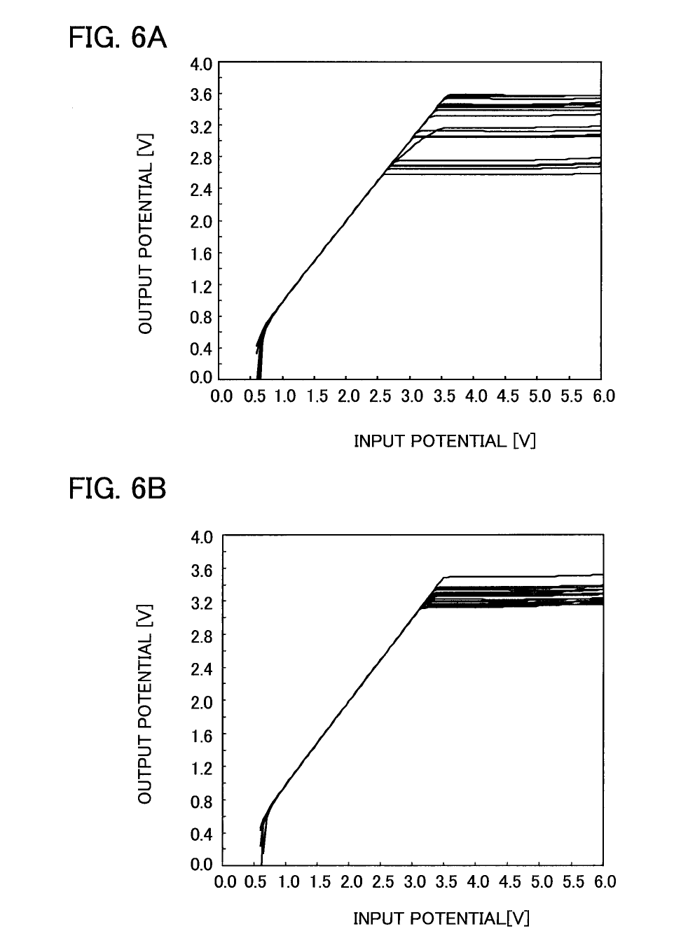

FIG. 6A shows comparison between measurements of the output potential VDD of a conventional regulator circuit in FIG. 2 and FIG. 6B shows comparison between measurements of the output potential VDD of the regulator circuit in FIG. 1.

In FIGS. 6A and 6B, horizontal axes indicate the input potential Vin, and vertical axes indicate the output potential VDD.

FIG. 6A shows that the output potential VDD of the regulator circuit varies within the range of 2.6 V to 3.6 V. Meanwhile, from FIG. 6B, it is shown that the output potential VDD of the regulator circuit remains within the range of 3.1 V to 3.4 V.

The comparison between the results shows that variations in the value of the output potential VDD between a plurality of regulator circuits are reduced by using the regulator circuit in FIG. 1.

This application is based on Japanese Patent Application serial no. 2009-175050 filed with Japan Patent Office on Jul. 28, 2009, the entire contents of which are hereby incorporated by reference.

What is claimed is:

1. A regulator circuit comprising:
a bias circuit referring threshold voltage;
an error amplifier;
an output control circuit; and
a feedback voltage divider,
wherein the feedback voltage divider comprises a diode-connected p-type transistor, and
wherein in terms of threshold voltage Vthn of an n-type transistor in the bias circuit referring threshold voltage and threshold voltage Vthp of the p-type transistor in the bias circuit referring threshold voltage, a standard deviation 3σ of the sum of Vthn and |Vthp| is smaller than a standard deviation 3σ of the Vthn.

2. A noncontact data-carrier comprising the regulator circuit according to claim 1.

3. A regulator circuit comprising:
a bias circuit referring threshold voltage;
an error amplifier;
an output control circuit; and
a feedback voltage divider,
wherein the bias circuit referring threshold voltage comprises first and second p-type transistors, first and second n-type transistors, and a first resistor,
wherein a gate of the first p-type transistor is electrically connected to a gate of the second p-type transistor and one of a source and drain of the second p-type transistor,
wherein one of a source and drain of the first p-type transistor is electrically connected to an input potential,
wherein the other one of the source and drain of the first p-type transistor is electrically connected to one of a source and drain of the first n-type transistor,
wherein a gate of the first n-type transistor is electrically connected to one end of the first resistor,
wherein the other one of the source and drain of the first n-type transistor is electrically connected to a ground potential,
wherein one of the source and drain of the second p-type transistor is electrically connected to one of a source and drain of the second n-type transistor,
wherein the other one of the source and drain of the second p-type transistor is electrically connected to the input potential,
wherein a gate of the second n-type transistor is electrically connected to the other one of the source and drain of the first p-type transistor,
wherein the other one of the source and drain of the second n-type transistor is electrically connected to one end of the first resistor,
wherein the other end of the first resistor is electrically connected to the ground potential,
wherein the feedback voltage divider comprises a diode-connected third p-type transistor, and
wherein in terms of threshold voltage Vthn of the first and second n-type transistors and threshold voltage Vthp of the third p-type transistor, a standard deviation 3σ of the sum of Vthn and |Vthp| is smaller than a standard deviation 3σ of the Vthn.

4. A noncontact data-carrier comprising the regulator circuit according to claim 3.

5. The regulator circuit according to claim 3, wherein the feedback voltage divider comprises a third p-type transistor and a second resistor,
wherein the output control circuit comprises a fourth p-type transistor,
wherein the error amplifier comprises fifth and sixth p-type transistors, and third to fifth n-type transistors,
wherein a gate of the third p-type transistor and one of a source and drain of the third p-type transistor are electrically connected to one end of the second resistor,
wherein the other one of the source and drain of the third p-type transistor is electrically connected to one of a source and drain of the fourth p-type transistor,
wherein the other one of the source and drain of the fourth p-type transistor is electrically connected to the input potential,
wherein the other end of the second resistor is electrically connected to the ground potential,
wherein one of a source and drain of the fifth p-type transistor is electrically connected to the input potential,
wherein the other one of the source and drain of the fifth p-type transistor is electrically connected to one of a source and drain of the third n-type transistor and a gate of the fourth p-type transistor,
wherein one of a source and drain of the sixth p-type transistor is electrically connected to the input potential,
wherein the gate and the other one of the source and drain of the sixth p-type transistor are electrically connected to a gate of the fifth p-type transistor,
wherein a gate of the third n-type transistor is electrically connected to a gate of the second n-type transistor,
wherein the other one of the source and drain of the third n-type transistor is electrically connected to one of a source and drain of the fifth n-type transistor,
wherein a gate of the fourth n-type transistor is electrically connected to the one end of the second resistor,
wherein one of a source and drain of the fourth n-type transistor is electrically connected to the other one of the source and drain of the sixth p-type transistor,
wherein the other one of the source and drain of the fourth n-type transistor is electrically connected to one of the source and drain of the fifth n-type transistor,
wherein a gate of the fifth n-type transistor is electrically connected to the one end of the first resistor, and
wherein the other one of the source and drain of the fifth n-type transistor is electrically connected to the ground potential.

6. A noncontact data-carrier comprising the regulator circuit according to claim 5.

7. A regulator circuit comprising:
a bias circuit referring threshold voltage;
an error amplifier, an output control circuit; and
a feedback voltage divider,
wherein the feedback voltage divider comprises a diode-connected n-type transistor, and
wherein in terms of threshold voltage Vthp of a p-type transistor in the bias circuit referring threshold voltage and threshold voltage Vthn of the n-type transistor, a standard deviation 3σ of the sum of Vthn and |Vthp| is smaller than a standard deviation 3σ of the Vthp.

8. A noncontact data-carrier comprising the regulator circuit according to claim 7.

9. A regulator circuit having an output terminal comprising:
a bias circuit referring threshold voltage comprising a one conductivity type transistor, output of the bias circuit depending on a threshold voltage of the one conductivity type transistor;
an amplifier configured to amplify a potential difference between two terminals, the output of the bias circuit is connected to a first terminal of the amplifier; and
an opposite conductivity type transistor to the one conductivity type transistor, the opposite conductivity type transistor having first, second, and gate electrodes,
wherein the first electrode of the opposite conductivity type transistor is connected to the output terminal of the regulator circuit, and
wherein the gate electrode of the opposite conductivity type transistor is connected one of the first and second electrode of the opposite conductivity type transistor,
wherein the second electrode of the opposite conductivity type transistor is connected to a second terminal of amplifier and a first terminal of a resistor.
wherein the output of the bias circuit and a feedback voltage inputted into the amplifier are the same value.

10. A noncontact data-carrier comprising the regulator circuit according to claim 9.
